(19) United States
(12) Patent Application Publication
(10) Pub. No.: US 2011/0139295 A1
(43) Pub. Date: Jun. 16, 2011

(54) Pouch Support For A Pressurized Dispensing Container

(76) Inventor: Christian T. Scheindel, Randolph Center, VT (US)

(21) Appl. No.: 12/638,281

(22) Filed: Dec. 15, 2009

(51) Int. Cl. B65B 3/04; B67D 7/84

(52) U.S. Cl. 141/2; 222/173; 222/464.1

(57) ABSTRACT

For use in a pressurized container that dispenses product, a pouch support has an upper edge that rests on the upper opening of the container and a sidewall that extends downwardly to a tail piece providing a port. At this port, the pouch is sealed to the tail piece. A dip tube integral with the pouch support extends down from the tail piece.

This arrangement permits filling the pouch in place in the container where the pouch is supported by the pouch support because the pouch opening is held open by the tail piece of the pouch support. Product that is ultimately dispensed , is filled through the port of the tail piece and through the dip tube. After the filling operation is completed, the valve is attached in place by crimping the valve cup to the upper opening of the container sidewall.

The dip tube has a plurality of sidewall openings that permit dispensing product when the pouch is pinched off at the dip tube.

### BACKGROUND OF THE INVENTION

This invention relates in general to a support for a pouch used in a pressurized dispensing container and more particularly to a support which holds the pouch open so that it can be filled before the valve for the dispensing container is assembled onto the container.

Pressurized dispensing containers for products such as gel shave and various food (e.g. mustard, ketchup and salad dressing) and cosmetic products have been used. These containers are sometimes called aerosol containers. That is a misnomer. Product dispensed does not need to be an aerosol. It can be of a number of different types of flowable products from low viscosity to relatively high viscosity.

The product to be dispensed is dispensed through a valve which is mounted on the container. When open, the valve is in communication with the product in the container.

A propellant, which is essentially gas under pressure, is used to force product out of the container when the valve is open. In one type of container, the propellant and product to be dispensed are separated by a movable piston. In another type of container, they are separated by a pouch. The pouch contains the product to be dispensed. The area outside of the pouch is pressurized with the gas propellant to push product out through the valve when the valve is opened.

This invention is directed to the latter type of design in which the pouch is used to contain the product to be dispensed. In the current art, the valve is mounted on the container before the product is added to the pouch. Then, the product is forced into the pouch through the opening in the valve. When this fill operation is completed and the valve is closed, some of the product will remain within the valve. This is particularly undesirable where food products are involved. The product may decompose before use, therefore limiting shelf life. Non-food products may set or cure thereby blocking the valve and also limiting shelf life.

Accordingly, it is a major purpose of this invention to provide a structure and technique for filling the product into a pouch without leaving product in the valve.

Achieving this result extends the shelf life of the filled dispensing container. For food products, the invention eliminates decomposition of the food within the valve. For many products, this invention minimizes or eliminates product setting or curing within the valve structure.

It is important to achieve the above purpose with a design that is inexpensive in structure and does not require expensive or complicated additional filling machinery.

### Definitions

### Upper and Lower.

The terms upper and lower or top and bottom or below and above are used herein to refer to relative positions in the container standing on a shelf with its bottom on the shelf and its valve extending upward. It should be understood that in use and, even possibly in storage, the positions relative to the earth can be in any orientation.

### Pouch Support.

The term “pouch support” refers to a device without the dip tube. The two pouch support embodiments shown are molded integral with the dip tube. The purpose of the pouch support is to hold the pouch open while the pouch is being filled. The dip tube component performs its usual product dispensing function.

### Outlet Port and Inlet Port.

The pouch support holds the pouch open during a fill operation. Thus during that operation, the pouch opening is an inlet port and the pouch support has an outlet port. However, in use to dispense product, the pouch opening operates as an outlet port. To facilitate understanding, the pouch opening may be referred to herein as a pouch upper opening. The opening in the pouch support may be referred to herein as the support ports.

### BRIEF DESCRIPTION

This pouch support is used with a hand held pressurized dispensing container for dispensing a product held in a pouch positioned within the container. The pouch is surrounded by a pressurized chamber. When a valve on top of the container is opened, product in the pouch is dispensed through the valve.

In brief, the pouch support has an upper edge, a lower port and an annular sidewall connecting the upper edge and port. The upper edge of the pouch support rests on the rim of the can. The sidewall of the support extends down and inward to a tail piece which defines the lower port. The pouch opening is sealed to the tail piece. A dip tube extends down from the tail piece in communication with the pouch support port and can be molded integral with the pouch support.

One or more openings can be located through the wall of the dip tube at locations below where the pouch is sealed to the pouch support. These openings provide product to be dispensed when the pouch pinches off around the dip tube. Alternatively a pouch support tail piece that is radially outboard and above the dip tube can have vertical openings to provide this alternate dispensing function.

During the fill operation, the pouch support with the pouch sealed thereto is placed in the container. Product is then forced into the pouch through the pouch support port and through the dip tube. After the pouch is filled, the valve is placed in position and the valve cup is crimped to the upper edge of the wall of the container thereby sealing the valve and pouch support to the container.

### BRIEF DESCRIPTION OF THE DRAWINGS

FIG. 1 is a longitudinal sectional view of one embodiment of the annular pouch support device 10 plus integral dip tube 11. This embodiment has auxiliary openings 12 in the sidewall of the dip tube. FIG. 1 shows the pouch support and dip tube prior to being assembled in the dispensing container.

FIG. 2 is a longitudinal sectional view, similar to that of FIG. 1, of a second embodiment, in which the auxiliary openings 13 are vertical openings in the tail piece 21 of the pouch support 10. FIG. 2A is a cross-sectional view along the plane A-A of FIG. 2.

FIG. 3 is a longitudinal sectional view showing the pouch 18 sealed to the FIG. 1 pouch support 10 with the combination mounted on a container 20 in position to have product filled into the pouch 18 through the opening 23 of the tail piece 21. In FIG. 3, the valve is not yet assembled to the container.

FIG. 4 is a longitudinal sectional view in partial relief similar to that of FIG. 3 except that the valve 22 is shown mounted on the pouch support 10 after the pouch 18 has been filled. The valve 22 has a mounting cap 26, stem 27 and sealing grommet 28, the latter two elements being shown in relief.

### DESCRIPTION OF THE PREFERRED EMBODIMENTS

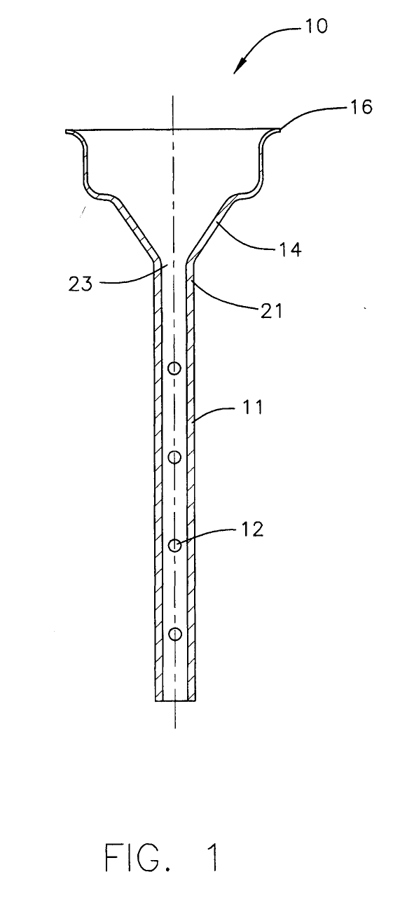

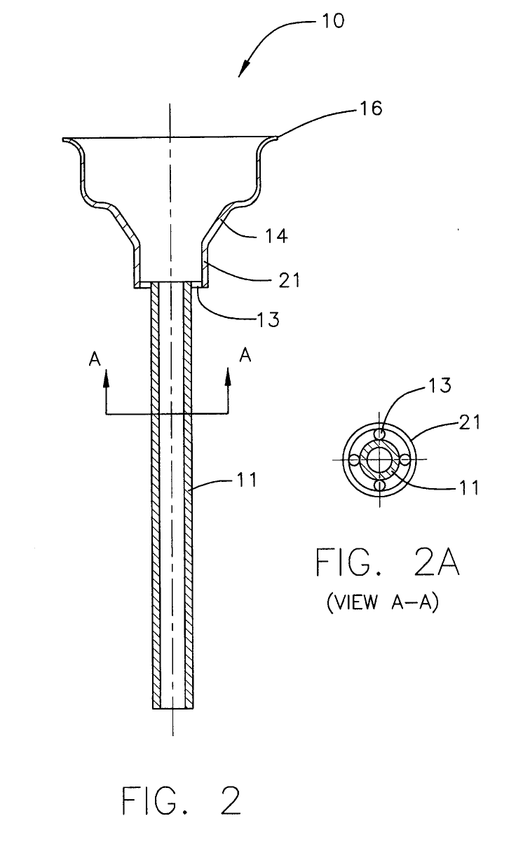

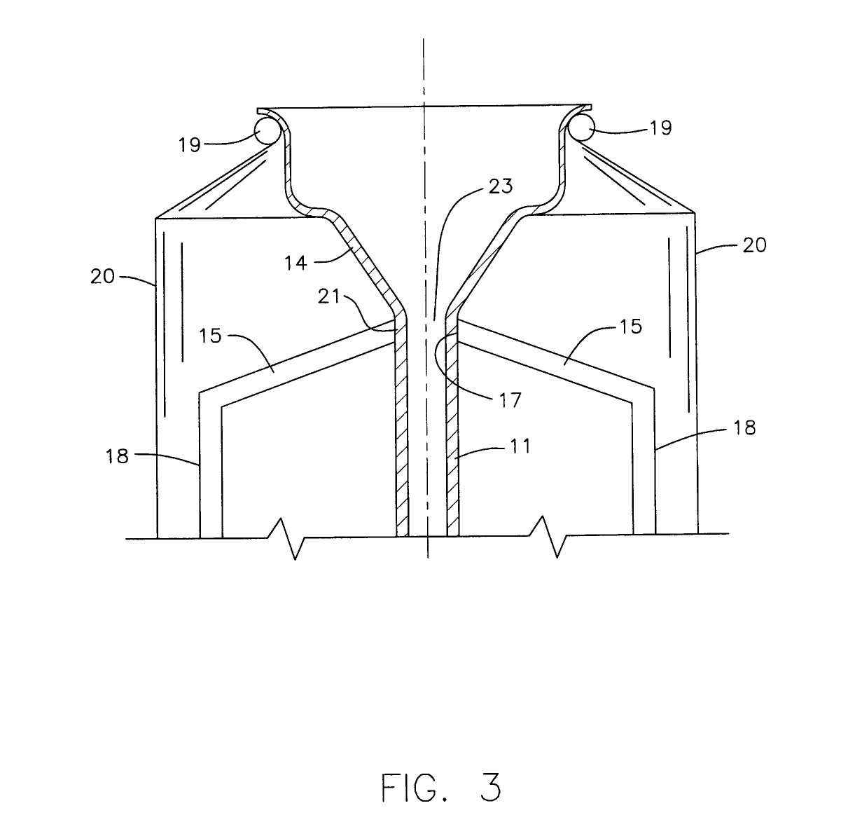

As shown in FIGS. 1 and 2, the pouch support 10 is an annular device having a tail piece 21 with the lower port 23 adapted to engage the upper opening 17 of the pouch 18 (See FIG. 3). This pouch support 10 has an annular sidewall 14 which terminates in an upper edge 16 that fits on the opening of the container 20 with which it is used. In both embodiments shown, a dip tube 11 is molded integral with the pouch support 10.

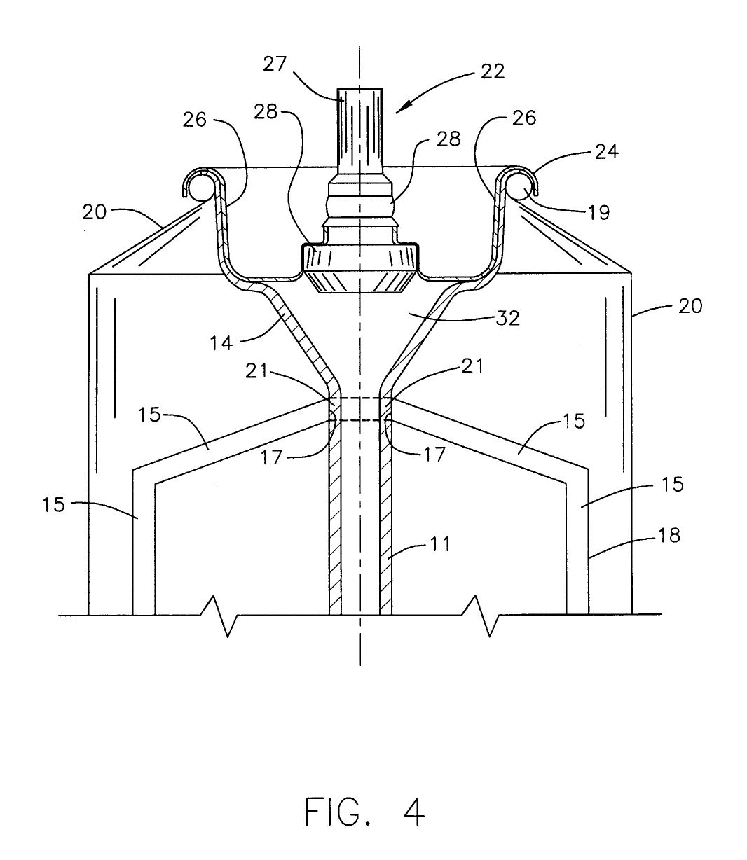

In FIG. 1, there are a series of small openings 12 in the sidewall of the dip tube 11. These openings 12 provide additional passage for product and are particularly useful when the pouch 18 pinches off around the dip tube 11. When the pouch 18 pinches off around the dip tube 11, product above the pinch zone is dispensed through these openings 12 into the space 32 under the valve (see FIG. 4) and out the valve 22, when the valve is open.

The arrangement in FIG. 2 with the openings 13 provides the same function as do the openings 11. However, in FIG. 2, the openings 13 are vertical openings through the annular tail piece 21 portion of the pouch support 10. In that embodiment, the tail piece 21 of the pouch support 10 extends radially outboard of the outer diameter of the dip tube 11.

As shown in FIGS. 3 and 4, the upper opening 17 of the pouch 18 is heat sealed at the zone 15 to the side wall of the tail piece 21 segment of the support 10. In the FIG. 1 embodiment, the tail piece 21 is continuous with the upper end of the dip tube 11.

The combined pouch support 10, dip tube 11 and pouch 18 is mounted on the container 20. The pouch support 10 has a turned upper edge 16 that rests on the upper edge 19 of the container 20. The pouch 18 may then be filled with the product to be dispensed through the tail piece 21 and pouch opening 17 and dip tube 11 in a known fashion. After filling, the valve 22 is added.

As shown in FIG. 4, the valve 22 has a cup 26. The upper circumferential edge 24 of the valve cup 26 is then crimped around the edge 16 of the pouch support and around the upper edge 19 of the container 20 . This seals the pouch support 10 and valve 22 to the container 20. In FIG. 4, the valve sealing grommet 28 and valve stem 30 are shown in relief

There is a space 32 beneath the valve 22 and above the support port 23 into which space 32 product flows when it is being dispensed through the opened valve 22.

In production, product to be dispensed is loaded into the pouch 18, until the pouch is filled, by a known product filling mechanism. When the pouch 18 is filled, the filling mechanism is removed and the valve 22 is mounted with the cup 26 crimped around the edges 16 and 19. As a consequence, there is no product in the valve 22 when the filling operation is completed.

Propellant under pressure is forced into the container space around the pouch 18. This pressure on the pouch, however, does not force product up into the valve 22 because the valve is closed at the point where propellant pressure is created.

In the FIG. 1 embodiment, there are openings 12 that extend through the sidewall of the dip tube 11. These openings 12 permit flow of product from the pouch 18 to the space 32 under the valve 22. Thus, if the pouch 18 pinches off around the dip tube 11, product above the pinch zone is dispensed through these openings 12 into the space 32 and out the valve 22, when the valve is opened. In the FIG. 2 embodiment, the vertical openings 13 in the tail piece 21 perform the function of the openings 12.

The pouch support 10 is shown with an integral dip tube 12. If the dip tube is not needed, the pouch support would terminate with a tail piece at 21 to which the pouch 18 is heat sealed. In the FIG. 1 embodiment, the tail piece 21 and dip tube 11 are an integral continuous tube.

A preferred dip tube 11 extends close to the length of the pouch. The pouch support 10 and dip tube 11 are preferably molded as a single piece. They could be molded separately and heat sealed to each other.

In FIG. 1, there are a series of small openings 12 in the sidewall of the dip tube 11. These openings provide additional passage for product and are particularly useful when the pouch 18 pinches off around the dip tube 11. When the pouch 18 pinches off around the dip tube 12, product above the pinch zone is dispensed through these openings 11 that are above the pinch zone into the space 32 and out the valve 22, when the valve is open.

The arrangement in FIG. 2 with the openings 13 provides the same function as do the openings 11. However, in FIG. 2, the openings 13 are vertical openings through the tail piece 21 of the pouch support 10. In that embodiment, the tail piece 21 of the pouch support 10 extends radially outboard of the outer diameter of the dip tube 11.

In one embodiment, the dip tube 11 extends 4.5 inches into a pouch having a depth of 5.5 inches. In that embodiment, there are two rows of openings 12 with six equally spaced openings in each row. That dip tube has a 140 mil diameter passageway and each opening is 40 mils in diameter. The magnitude of the passageway and the size of the openings will in part be a function of the viscosity of the product being dispensed.

While the foregoing description and drawings represent the presently preferred embodiments of the invention, it should be understood that those skilled in the art will be able to make changes and modifications to those embodiments without departing from the teachings of the invention and the scope of the claims.

What is claimed is:

1. In a pressurized dispensing container having a pouch for containing product to be dispensed and a valve at the upper opening of the pouch for controlling the rate at which product is dispensed, the valve including a mounting cup crimped onto the upper edge of the container, a product filling mechanism comprising:
a pouch support for holding the pouch in position while the pouch is being filled without the valve in place, said pouch support having a tail piece with a port at its lower end,
said tail piece adapted to be sealed to the opening of the pouch to hold the pouch open during filling of product,
said pouch support having an upper end adapted to be fitted onto the upper edge of the container.
said pouch support having a wall extending between said tail piece and said upper end of said pouch support.

2. The pouch support of claim 1 further comprising: a dip tube attached to and in communication with said port of said tail piece.

3. The pouch support of claim 2 further comprising: at least one opening in the side wall of said dip tube below the zone where the pouch is sealed to said tail piece to provide product discharge there through when the pouch is pinched off.

4. The improvement of claim 2 further comprising: at least one opening in the sidewall of said dip tube below the zone where the pouch is sealed to said tail piece to provide product discharge there through when the pouch is pinched off.

5. The pouch support of claim 1 further comprising: at least one tail piece opening extending vertically through said tail piece to provide product discharge there through when the pouch is pinched off.

6. The pouch support of claim 2 further comprising: at least one tail piece opening extending vertically through said tail piece to provide product discharge there through when the pouch is pinched off.

7. The method of filling a pouch for use in a pressurized dispensing container comprising the steps of:
supporting the pouch near the top of the container with a pouch support element that rests on the top opening of the container and which has a lower tail piece that engages and holds open the opening of the pouch to support the pouch in position within the container,
then filling the pouch with product which will eventually be dispensed,
after filling has stopped, mounting a dispensing valve with a valve cup in said pouch support element, said valve being nested in said pouch support element, and
then crimping the upper edge of the valve cup around the upper edge of the container thereby sealing the valve and pouch support to the container.

8. A dip tube improvement for a pouch containing product in a pressurized dispensing container in which product is dispensed through a valve that controls the dispensing of product, the improvement comprising:
a dip tube having a plurality of longitudinally and circumferentially disposed openings to provide alternate communication between the product being dispensed and the dip tube passageway.

9. The dip tube of claim 8 wherein said dip tube has two longitudinal rows of openings with six openings in each row.

10. The dip tube of claim 8 wherein each of said openings is substantially 40 mils in diameter.

11. The dip tube of claim 9 wherein each of said openings is substantially 40 mils in diameter.
